(19) United States
(12) Patent Application Publication
(10) Pub. No.: US 2024/0208280 A1
(43) Pub. Date: Jun. 27, 2024

(54) TIRE INSTALLATION TOOL

(71) Applicant: Kevin James BAKER, Penallta, Hengoed Mid Glamorgan (GB)

(72) Inventor: Kevin James BAKER, Penallta, Hengoed Mid Glamorgan (GB)

(21) Appl. No.: 18/557,607

(22) PCT Filed: Feb. 28, 2022
(86) PCT No.: PCT/GB2022/050535

§ 371 Date: Oct. 27, 2023

(30) Foreign Application Priority Data
Apr. 27, 2021 (GB) 2105973.8

(51) Int. Cl. B60C 25/04

(52) U.S. Cl. CPC B60C 25/04

(57) ABSTRACT

A tool for installing a tire on a wheel rim comprises a body and a wing. The wing extends from an upper portion of the body to form an overhang over a side of the body, such that the side of the body and an underside of the wing from an open channel for receiving in use an outer peripheral portion of a wall of the wheel rim. The channel extends between a forward portion and a rearward portion of the body. The wing comprises a leading edge and an upper side which are arranged to engage in use with a side wall of the tire. The leading edge of the wing is swept toward the rearward portion of the body and the upper side of the wing is curved about an axis which extends substantially along the channel, to form a convex profile.

### CROSS-REFERENCE TO RELATED APPLICATIONS

This application claims priority pursuant to 35 U.S.C. 119(a) to International Patent Application No. PCT/GB2022/050535, which international application claims priority to United Kingdom Application No. 2105973.8, filed Apr. 27, 2021, which applications are incorporated herein by reference in their entireties.

### FIELD

The present invention relates to tools for installing bicycle tires on bicycle wheel rims and/or removing bicycle tires from bicycle wheel rims.

### BACKGROUND

Installing bicycle tires on and removing bicycle tires from wheel rims is an essential aspect of bicycle maintenance and repair. Depending on the type of tire and wheel rim utilized, the ease with which a tire can be installed on or removed from the wheel rim can vary greatly depending on how tightly the tire fits on the wheel rim. Where a tire is, or is to be, mounted tightly on a wheel rim, it may be necessary to employ a tool, such as a tire lever, to aid a user in lifting the tire bead and corresponding section of the tire side wall over the wheel rim during installation or removal of the tire.

It is very well known to use a tire lever to facilitate the installation of a tire on a wheel rim and to allow the removal of a tire from a wheel rim. When installing the tire, a tire lever may be used to ease the tire over the side wall of wheel rim. During removal of the tire, the lever may be placed between a wheel rim and tire bead in use, with pressure being applied to the tire lever to lift the corresponding section of the tire bead and tire wall away from the wheel rim; an example is disclosed in WO9813221.

U.S. Pat. No. 9,656,524 discloses a further example of a tire lever for removing and installing bicycle tires. The tire lever comprises a first hook for removing a tire and a second hook for installing a tire. The tool may be moved circumferentially around the wheel rim in use, with the length of the tool being orientated generally radially with respect to the wheel.

Known bicycle tire levers are generally elongate, with the length of the tire lever extending radially towards the centre of the bicycle wheel in use. Such levers comprise a relatively narrow hook or lever section which is positioned between a tire and a wheel rim in use. Where a tire is fitted tightly on a wheel rim, it may be necessary to use a series of tire levers to ease the tire onto or away from the wheel rim. If a tire lever is narrow, the pressure exerted on or by the tire lever when it is located between the tire and the wheel rim may make it difficult to move the tire lever circumferentially around the wheel rim to ease the tire either onto or away from the wheel rim, and in some cases may result in damage to the wheel rim.

Accordingly, it is an object of the invention to alleviate the disadvantages of the prior art.

### SUMMARY

A tool for installing a tire on a wheel rim, the tool comprising:
a. a body;
b. a wing extending from an upper portion of the body to form an overhang over a side of the body, such that the side of the body and an underside of the wing from an open channel for receiving in use an outer peripheral portion of a wall of the wheel rim, the channel extending between a forward portion and a rearward portion of the body;
c. the wing comprising a leading edge and an upper side which are arranged to engage in use with a side wall of the tire;
   characterised in that the leading edge of the wing is swept toward the rearward portion of the body and the upper side of the wing is curved about an axis which extends substantially along the channel, to form a convex profile.

A radius of curvature of the upper side of the wing about the axis may increase from the leading edge toward a trailing edge of the wing.

The tool may further comprise guiding means disposed upon the upper portion of the body for guiding the side wall of the tire upon the wing.

The guiding means may be disposed along the body between the wing and the forward portion of the body. The guiding means may comprise a ramped protuberance formed upon the upper portion for lifting the side wall of the tire upon the wing.

The tool may further comprise an abutment surface for engaging with the side wall of the tire and deflecting the side wall of the tire upon the upper side of the wing. The abutment surface may comprise a quarter sphere.

The tool may comprise a flange for removal of a tire from a wheel rim.

The flange may extend from the side of the body opposite the side from which the wing extends. The flange may be located proximate the rearward portion of the body. The flange may extend between the upper portion and a lower portion of the body and may extend substantially perpendicularly to the body.

The width of the flange may be 20-60 mm, preferably 30-50 mm or more preferably 40-50 mm.

In a second aspect of the invention, there is provided a tool for removal or a tire from a wheel rim, the tool comprising a body and a flange extending from a side of the body and extending substantially perpendicularly to the body.

The width of the flange may be 20-60 mm, preferably 30-50 mm or more preferably 40-50 mm.

### BRIEF DESCRIPTION

Various embodiments are disclosed, by of example only, with reference to the accompanying schematic drawings in which corresponding reference symbols indicate corresponding parts or components, in which:

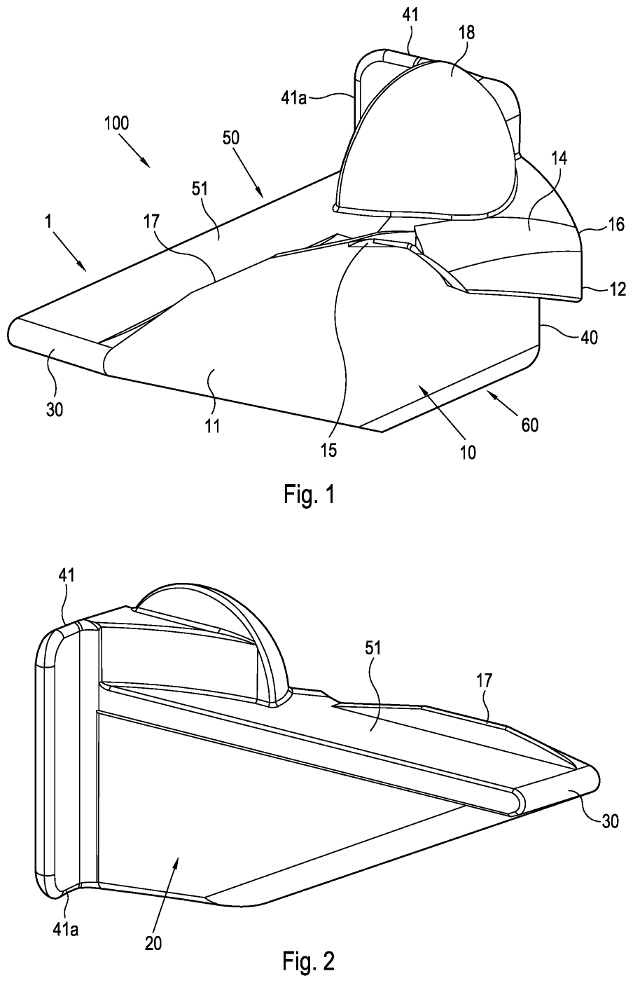

FIG. 1 is a first perspective view of a tool according to an embodiment of the present invention;

FIG. 2 is a second perspective view of the tool of FIG. 1;

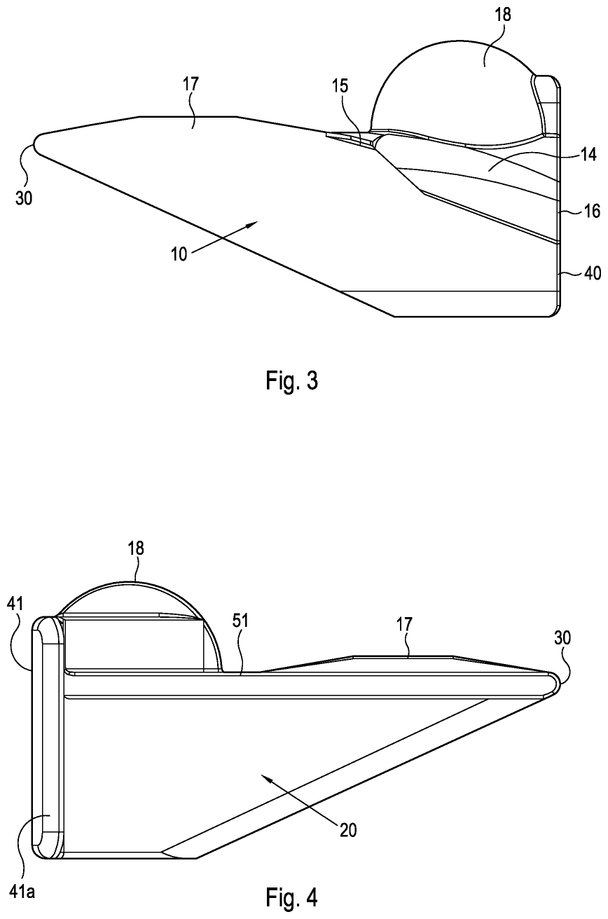

FIG. 3 is a view of a first side of the tool of FIG. 1;

FIG. 4 is a view of a second side of the tool of FIG. 1;

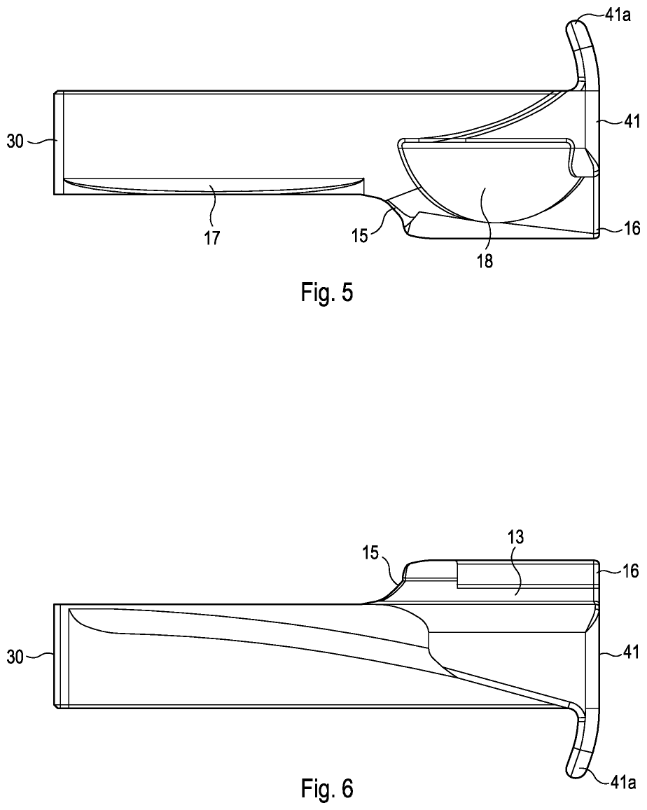

FIG. 5 is the tool of FIG. 1 as viewed from above;

FIG. 6 is the tool of FIG. 1 as viewed from below;

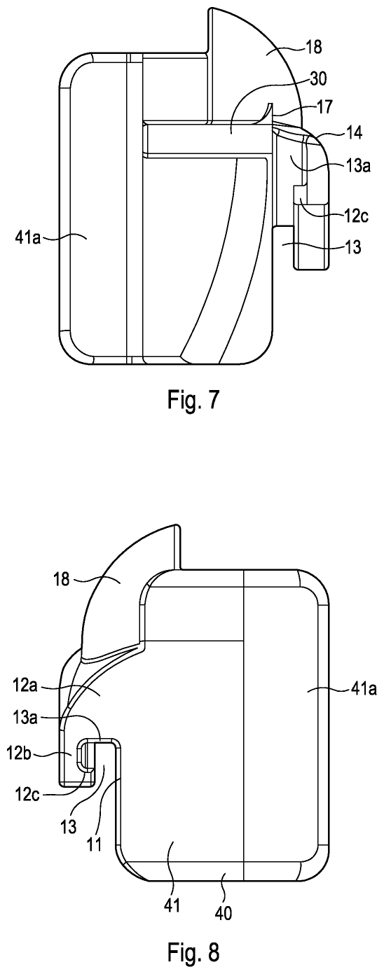

FIG. 7 is a side view from the forward portion of the tool of FIG. 1;

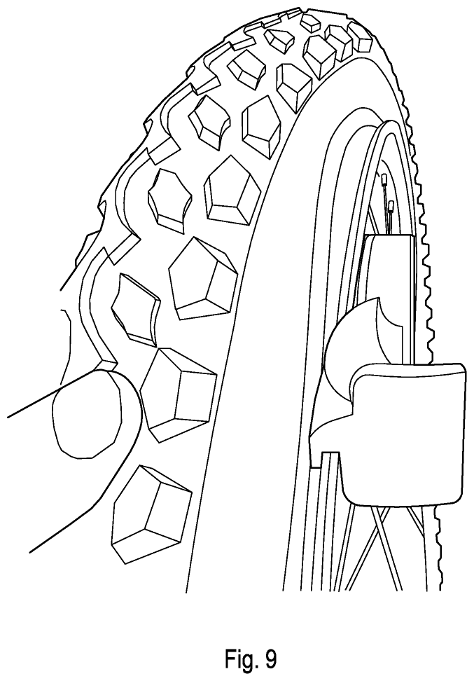

FIG. 8 is a side view from the rearward portion of the tool of FIG. 1;

FIG. 9 is a back view of the tool of FIG. 1 in use during installation of a tire on a wheel rim; and,

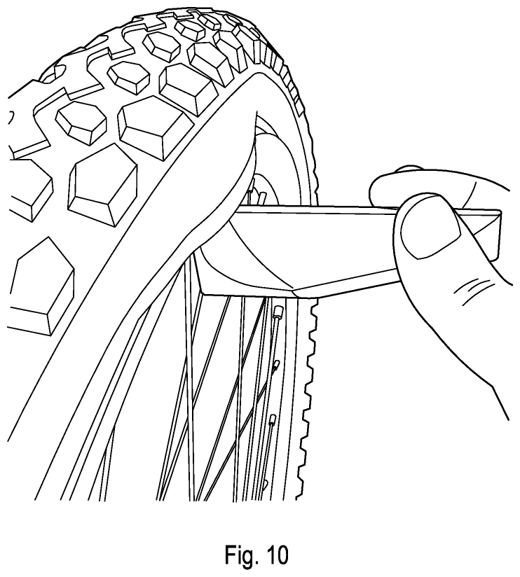

FIG. 10 shows the tool of FIG. 1 in use during removal of a tire from a wheel rim.

### DETAILED DESCRIPTION

Referring to FIGS. 1-10, there is shown a tool according to an embodiment of the present invention.

The tool 100 comprises a body 1 comprising a first side 10, a second side 20, a forward portion 30, a rearward portion 40, an upper portion 50 and a lower portion 60, in use. The tool 100 may be made from any material of suitable strength, for example plastics material or metal.

In the illustrated embodiment, the body 1 is generally elongate, and the first side 10 comprises a planar face 11. The length of the body 1 extends between the forward portion 30 and the rearward portion 40, and the upper portion 50 and lower portion 60 of the body 1 converge towards the forward portion 30.

The first side 10 of the body 1 comprises a wing 12, a guiding means 17 and an abutment surface 18.

As shown in FIG. 8, a first part 12a of the wing 12 extends outwardly from the first side 10 and a second part 12b of the wing 12 extends from the first part 12a in a direction which is substantially parallel with the planar face 11 of the body 1, thereby forming an overhang. The wing 12 and a section of the planar face 11 form a substantially U-shaped open channel 13, as shown in FIGS. 8 and 9. The inner surface of the wing 12 comprises a lip 12c, which extends towards the planar face 11. The lip 12c extends at least partially along the length of the inner surface of the wing 12 in a direction extending between the forward portion 30 and the rearward portion 40.

The wing 12 has a leading edge 15 which is proximal to the forward portion 30 of the body 1, as shown in FIGS. 1 and 7. A trailing edge 16 of the wing 12 is proximal to the rearward portion 40 of the body 1, as shown in FIGS. 1 and 8. The outer surface 14 of the wing 12 is curved as it extends between the leading edge 15 and the trailing edge 16, as shown in FIG. 3. The leading edge 15 of the wing 12 is swept toward the rearward portion of the body, as shown in FIG. 5.

An inner surface portion 13a, which forms part of the channel 13, may also be curved between the leading edge 15 and trailing edge 16 of the wing 12 with a radius of curvature similar to or the same as that of the circumference of the wheel rim. Alternatively, the inner surface portion 13a may comprise one linear surface or a series of linear surfaces extending between the leading edge 15 and the trailing edge 16.

The outer surface 14 of the wing 12 is also curved as it extends outwardly from the first side 10 to form a convex surface about an axis which is parallel to an axis extending between the leading edge 15 and the trailing edge 16, as illustrated in FIGS. 1, 7 and 8. The axis about which the surface is curved may extend substantially along the channel. This radius of curvature of the convex profile of the surface of the outer surface 14 at the leading edge 15 (as shown in FIG. 7) is smaller than the radius of curvature of the convex profile at the trailing edge 16 (as shown in FIG. 8). The radius of curvature gradually increases from the leading edge 15 to trailing edge 16.

While in the illustrated embodiment the outer surface 14 of the wing 12 is curved, the skilled person will appreciate that other equivalent surface profiles may be used, for example, one of more angled surfaces.

Adjacent to the wing 12 is the guiding means 17, which extends from an upper surface 51 of the body 1 in use. When viewed from the first side 10, the guiding means 17 is tapered in the direction of the forward portion 30 and in the direction of the rearward portion 40 also, forming a ramped protuberance upon the upper portion 50 of the body 1. When viewed from above (as shown in FIG. 5), the guiding means has a curved surface. The guiding means 17 is for guiding the side wall of the tire towards the wheel rim and onto the wing 12 in use.

The abutment surface 18 is for guiding a tire towards the wheel rim and aligning the tire with the wing 12 in use. In the illustrated embodiment, the abutment surface 18 comprises a quarter sphere, although it will be understood that any shaped surface which is capable of guiding a tire towards the wheel rim and aligning the tire with the wing 12 may be used.

The second side 20 of the body comprises a holding region for holding by a user. The holding region may be used to manipulate the tool 100 in use. In the illustrated embodiment, the holding region comprises both the upper surface 51 of the body 1 and an end section 41 proximate the rearward portion 40 of the body 1. The end section 41 extends substantially perpendicularly to the upper surface. In the illustrated embodiment, the end section 41 also comprises a flange 41a, the width of which extends along the full length of the end section 41. The flange 41a extends from the second side 20 of the body 1. The flange 41a may extend substantially perpendicularly from the second side 20 of the body 1, and/or may form an acute angle with the second side 20, which may be greater than 45 degrees. In a preferred embodiment, the acute angle is greater than 50 degrees, preferably greater than 60 degrees and more preferably greater than 70 degrees. In a preferred embodiment, the width of the flange 41a is 20-60 mm, preferably 30-50 mm and more preferably 40-50 mm.

Use of the invention to install and remove a tire on a wheel rim will now be described with reference to the illustrated embodiment.

When installing a tire on a wheel rim a user can usually, without the use of a tool, lift a tire over a wheel rim wall so that a first side wall of the tire is wholly seated in the channel of the wheel rim. A section of the second side wall of the tire may also be lifted over the wheel rim fairly easily and without the use of a tool so that the tire second side wall is partially installed on the wheel rim. However, once the first side wall and part of the second side wall are installed, it can be difficult if not impossible to lift the remainder of the second side wall over the wheel rim wall without the use of the tool because of the tight fit of the tire and/or its inflexibility. At this stage, it becomes necessary to employ a tool to install the remainder of the second side wall on the wheel rim.

Once the second side wall is partially installed on a wheel rim, the tool 100 may then be used to lift the bead of the second side wall and corresponding section of the tire side wall over the wheel rim so that the entirety of the tire second side wall may be seated in the channel of the wheel rim.

To achieve this, the user orientates the tool 100 so that the first side 10 of the body 1 faces the tire and the wheel rim, and the second part 12b of the wing 12 extends towards the centre of the wheel. The user inserts the second part 12b between the wheel rim and the tire second side wall which is already seated in the channel of the wheel rim. The corresponding portion of the wheel rim side wall is therefore located in the channel 13 of the tool 100.

To install the remainder of the second side wall on the wheel rim, the user moves the tool around the wheel rim circumferentially, while maintaining the wheel rim side wall in the channel 13. When the tool 100 of the illustrated embodiment is engaged with the wheel rim as described, the user pushes on the end section 41 to move the tool 100 circumferentially relative to the wheel rim in a clockwise direction (when viewed from the second side 20) towards the section of the tire second side wall which is not yet installed on the wheel.

As the forward portion 30 engages the uninstalled section of the tire second side wall, the user continues to move the tool circumferentially so that the guiding means 17 guides the uninstalled section inwardly towards the wheel rim side wall. As the user continues to move the tool circumferentially, the same portion of the uninstalled section engages the abutment surface 18, which further guides the uninstalled section towards the wheel rim and the wing leading edge 15. As the tool continues to move circumferentially around the wheel rim, the tire bead and side wall of the uninstalled section move over the curved outer surface 14 of the wing 12 and are thereby eased over the side wall of the wheel rim. The user continues to push the tool 100 circumferentially around the wheel rim to feed the tire bead and side wall onto the wheel rim until the entirety of the tire second side wall is installed on the wheel rim, as shown in FIG. 9.

To remove a tire from a wheel rim, the user pushes the flange 41a underneath part of the tire bead on one of the side walls of the tire so that the tire bead is lifted and the flange 41a is located between the tire bead and the wheel rim. In this configuration, the flange 41a is therefore located behind the tire side wall. The user orientates the tool so that the end section 41 is substantially parallel with the corresponding part of the wheel rim outer wall, and in doing so further lifts the tire bead over and away from the wheel rim, as shown in FIG. 10. The tool may then be moved circumferentially around the wheel rim until all of the tire side wall has been removed from the wheel rim, or until enough of the tire side wall has been removed for a user to continue to remove the tire without the use of the tool. The tool may be moved circumferentially in either rotational direction to achieve this.

The end section 41 has a larger surface area than the equivalent lever or hook sections of prior art tire levers. The orientation of the body 1 relative to the flange 41a also increases the surface area of the tool 100 which is in contact with the wheel rim, and particularly with the flat outer side wall of the wheel rim, compared to the known prior art.

These features may provide the advantage of spreading the force exerted by the tool 100 across a larger surface area of the wheel rim and avoiding putting undue pressure on the outermost edge of the wheel rim, thereby making it easier to move the tool 100 circumferentially around the wheel rim in use and avoiding damage to wheel rim.

When a sufficient proportion of the tire side wall has been removed from the wheel rim, a user may choose to remove the remainder of the tire from the wheel rim without using the tool.

While the illustrated embodiment comprises the features required for installing a tire on wheel rim and the features required for removing a tire from a wheel rim, the tool may comprise only the features required for installing the tire or only the features required for removing the tire.

1. A tool for installing a tire on a wheel rim, the tool comprising:
a body;
a wing extending from an upper portion of the body to form an overhang over a side of the body, such that the side of the body and an underside of the wing from an open channel for receiving in use an outer peripheral portion of a wall of the wheel rim, the channel extending between a forward portion and a rearward portion of the body; and,
the wing comprising a leading edge and an upper side which are arranged to engage in use with a side wall of the tire;
wherein the leading edge of the wing is swept toward the rearward portion of the body and the upper side of the wing is curved about an axis which extends substantially along the channel, to form a convex profile.

2. The tool according to claim 1, wherein a radius of curvature of the upper side of the wing about the axis increases from the leading edge toward a trailing edge of the wing.

3. The tool according to claim 1 further comprising guiding means disposed upon the upper portion of the body for guiding the side wall of the tire upon the wing.

4. The tool according to claim 3, wherein the guiding means is disposed along the body between the wing and the forward portion of the body.

5. The tool according to claim 3 wherein the guiding means comprises a ramped protuberance formed upon the upper portion for lifting the side wall of the tire upon the wing.

6. The tool according to claim 1 further comprising an abutment surface for engaging with the side wall of the tire and deflecting the side wall of the tire upon the upper side of the wing.

7. The tool according to claim 6 wherein the abutment surface comprises a quarter sphere.

8. The tool according to claim 1 comprising a flange for removal of a tire from a wheel rim.

9. The tool according to claim 8 wherein the flange extends from the side of the body opposite the side from which the wing extends.

10. The tool according to claim 8 wherein the flange is located proximate the rearward portion of the body.

11. The tool according to claim 8 wherein the flange extends between the upper portion and a lower portion of the body.

12. The tool according to claim 8 wherein the flange extends substantially perpendicularly to the body.

13. The tool according to claim 8 wherein the width of the flange is 20-60 mm.

14. The tool according to claim 13 wherein the width of the flange extending between the upper and lower portion of the body is 30-50 mm.

15. The tool according to claim 14 wherein the width of the flange extending between the upper and lower portion of the body is 40-50 mm.
